(19) United States
(12) Patent Application Publication
(10) Pub. No.: US 2016/0379515 A1
(43) Pub. Date: Dec. 29, 2016

(54) SYSTEM AND METHOD FOR ENHANCING LOGICAL THINKING IN CURATION LEARNING

(71) Applicant: FUJITSU LIMITED, Kawasaki-shi (JP)

(72) Inventors: Yuko OKUBO, Berkeley, CA (US); Jun WANG, San Jose, CA (US); Kanji UCHINO, San Jose, CA (US)

(21) Appl. No.: 14/754,251

(22) Filed: Jun. 29, 2015

(51) Int. Cl. G09B 19/00; G09B 5/02; G09B 7/02

(52) U.S. Cl. CPC G09B 19/00; G09B 7/02; G09B 5/02

(57) ABSTRACT

A method of enhancing logical thinking in a curation learning system. The method comprises receiving an original curation and an existing curation, newly-added curation, or clipped items of content, analyzing content in the original curation, additional curation and clipped items, comprising an existing curation, newly-added curation, or clipped items to identify a plurality of key topics, identifying an opinion orientation of the content of the original curation and the additional curation, creating a visualization of the opinion orientation of the plurality of content of the original curation and the additional curation and clipped items with respect to the key topics, matching the identified opinion orientation and key topics of the original curation and the additional curation and clipped items, generating a notification of the matched opinion orientation and key topics of the original curation, newly-added curation, existing curation and clipped items, and presenting the user with a guidance display.

### FIELD

The embodiments discussed herein are related to a system and method for guiding and enhancing logical thinking using curated content.

### BACKGROUND

Curations may include a list of items, such as digital files, that are organized by a curator. Curations may combine various forms of content. The curation may include a list of items, such as digital files and/or online media, which are organized by a curator. The curation may also include content created by the curator that characterizes or otherwise describes the items. For example, curations may include digital files generated by the curator with web content accessed via a network such as the internet. Additionally, curations may include modifications to web content by the curator. The items in the curations may be organized according to topic or theme. One difficulty with existing curation systems, however, is that when human users are responsible for curations, it is difficult to be unbiased in finding, collecting, and curating information and web content due to human subjectivism.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method of enhancing logical thinking in curation learning system is disclosed. The method includes receiving an original curation of a plurality of content, analyzing the plurality of content of the original curation to identify a plurality of key topics which are associated with the content, identifying an opinion orientation of the content of the original curation indicating an opinion orientation of the content of the original curation with respect to the key topics, creating a visualization of the opinion orientation of the plurality of content of the original curation, analyzing the plurality of content of an existing curation, newly-added curation, or clipped items in an electronic clipboard to identify a plurality of key topics which are associated with the content of the existing curation, newly-added curation, or clipped items in an electronic clipboard, identifying an opinion orientation of the content of the existing curation, newly-added curation, or clipped items indicating an opinion orientation of the content of the existing curation, newly-added curation, or clipped items with respect to the key topics, creating a visualization of the opinion orientation of the plurality of content of the existing curation, newly-added curation, or clipped items, matching the identified opinion orientation and key topics of the plurality of content of the original curation and the plurality of content of the existing curation, newly-added curation, or clipped items, generating a notification for enhancing the logical thinking of a user based on the matched identified opinion orientation and key topics of the plurality of content of the original curation and the plurality of content of the existing curation, newly-added curation, or clipped items, and presenting the user with a guidance display for enhancing the logical thinking of a user based on the matched identified opinion orientation and key topics of the plurality of content of the original curation and the plurality of content of the existing curation, newly-added curation, or clipped items.

According to another aspect of an embodiment, a guided learning and curation system is disclosed. The system includes a processor and a non-transitory computer-readable storage medium communicatively coupled to the processor and having computer-executable instructions stored thereon that are executable by the processor to perform operations. The operations performed by the processor include receiving an original curation of a plurality of content, analyzing the plurality of content of the original curation to identify a plurality of key topics which are associated with the content, identifying an opinion orientation of the content of the original curation indicating an opinion orientation of the content of the original curation with respect to the key topics, creating a visualization of the opinion orientation of the plurality of content of the original curation, analyzing the plurality of content of a newly-added curation, existing curation, and clipped item to identify a plurality of key topics which are associated with the content of the newly-added curation, existing curation, and clipped item, identifying an opinion orientation of the content of the newly-added curation, existing curation, and clipped item indicating an opinion orientation of the content of the newly-added curation, existing curation, and clipped item with respect to the key topics, creating a visualization of the opinion orientation of the plurality of content of the newly-added curation, existing curation, and clipped item matching the identified opinion orientation and key topics of the plurality of content of the original curation and the plurality of content of the newly-added curation, existing curation, and clipped item, generating a notification for enhancing the logical thinking of a user based on the matched identified opinion orientation and key topics of the plurality of content of the original curation and the plurality of content of the newly-added curation, existing curation, and clipped item, and presenting the user with a guidance display for enhancing the logical thinking of a user based on the matched identified opinion orientation and key topics of the plurality of content of the original curation and the plurality of content of the newly-added curation, existing curation, and clipped item.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments may be implemented;

FIG. 2 illustrates a block diagram depicting an example curation guidance system that may be included in the operating environment of FIG. 1;

FIG. 3 is a flow diagram of an example method of performing curation guidance using the system of FIG. 2 in accordance with at least one embodiment described herein;

FIG. 4 is an example of a visual representation of the opinion orientation of a curation of content which may be generated according to one embodiment;

FIG. 5 is an example of a note which may be attached to selected content in order to guide the user through a learning or curation process using the system and methods described herein;

FIGS. 6-7 illustrate an example of a guided curation system which may include the ability to add new content and identify the relationship between new content in the context of a newly-added curation, existing curation, and clipped item using the system and methods described herein;

FIG. 8 is an example of a visual opinion orientation which illustrates the relationship and correlation between different items of different curations which may be organized by viewpoint; and

FIG. 9 is an example of a user interface of a guided curation system which may be generated using the systems and methods described herein.

### DESCRIPTION OF EMBODIMENTS

Some embodiments discussed herein are related to improving and enhancing logical thinking in curation learning. As is described more fully below, the system and method described in the following embodiments enable users or curators to update their curations and self-educate themselves on a topic of interest in an unbiased manner by assembling a wider assembly of information or content than is generally provided by systems that are currently available in the art. In 1956, Benjamin Bloom developed a classification of learning objectives, which covered three domains and six levels. These domains and levels are still considered useful today. The three domains include a cognitive or head domain, a psychomotor or hand domain, and an affective or heart domain. Within the cognitive domain, Bloom identified six levels, identified as follows:

Level 1: Knowledge, which corresponds to ‘who,’ ‘what,’ ‘where,’ and other questions relating to content;
Level 2: Comprehension, which corresponds to a re-telling or assessment of a main idea of a particular item of content;
Level 3: Application, which corresponds to applying information for interpretation, such as providing a corresponding example, demonstration, or explaining the significance of an item of content;
Level 4: Analysis, corresponding to comparing, contrasting distinguishing, examining of component parts of content;
Level 5: Synthesis, which corresponds to combining a variety of ideas or different items of content to form a new whole or an additional piece of content; and
Level 6: Evaluate, which corresponds to appraising, deciding, judging, and rating content.

Generally, in order for a user to engage in level 5 or 6 learning, it is critical for the level 4 analysis to be performed. In order to perform that level 4 analysis, it is necessary to provide the user or curator with a contradictory component to an item of content. As is described more fully below, the embodiments herein are able to detect a contradictory component, categorize, compare, contrast and examine the contradictory component to other curated content and clipped items in order to enable a user to identify a contradiction and examine the differences between the different items of content. Such a system provides a user with different viewpoints and enables the user to perform the analysis required for a deeper understanding of a topic or item.

Examples of the types of questions that may be asked to a user during the analysis phase in order to deepen the user's understanding include identifying the differences between a particular item of content and the contradictory component, identifying how a particular item is related to another item, how two different items compare or contrast with each other and what evidence can be presented for an item of content. Similarly, examples of questions that can be asked during the synthesis and evaluation phases in order to even further deepen a user's logical thinking include asking what ideas can be added to an item of content, what inferences can be made if two different items of content are combined, what the user thinks of a topic or subject matter of the item of content or what the most important topic of the item of content.

Many traditional curation systems are targeted to teachers or students for a classroom environment as a framework which helps students learn various critical thinking skills. One such method, entitled “Method for Teaching Critical Thinking” by Kevin S. Winterrowd, consists of teaching the students using Bloom's Taxonomy in three different steps. First, the student is prompted to identify the concept under consideration. Then the student is asked to analyze the significance of the concept in relation to at least one relatively narrow context, and then the student is instructed to evaluate the significance of the concept in relation to at least concept which is relatively broader. One of the limitations of this system, however, is that it is not based in a computer environment, meaning that the concept and learning steps have to be manually processed by hand. Further, the method is used in a traditional teaching environment and does not assist a user in a self-guided system. Hence, it requires a traditionally structured system where the learning is supervised by an instructor.

As will be described more fully below, embodiments described more fully herein provide support for critical thinking guidance. The embodiments are directed to both students and instructions and guide users based on notification of both similar and contradictory content. The system is based in a computer environment and uses automatically extracted descriptions and notes in multiple data sources, including text, visual data, PDFs, and other types of data content, and prompts the user to identify or discover missing information or links between the different data in order to create a more balanced understanding of the topic. As may be understood by one of skill in the art, by guiding a user through an automatically generated guidance system and identifying and presenting the user with similar, contradictory or other related content, users are able to discover missing, similar, contradictory or other related information in order to develop a more robust and sophisticated understanding of a concept. As is described more fully below, the system and embodiments herein provide notification and guidance using a series of semi-automatically generated notification templates or automatically generated notification templates.

Embodiments of the present invention will be explained with reference to the accompanying drawings.

An example embodiment includes a method of collecting learning materials for informal learning and presenting the materials to a user so that the user may obtain a deeper and more sophisticated understanding of the materials. The method may include obtaining a set of data, identifying key words or other relevant information in the data in order to identify key topics of information in the curation in addition to an opinion orientation of the items in order to create a visualization and display illustrating key topics of the curation and how the items within the curation relate to each other and the key topics. Using this curation, a newly added curation, existing curation, and/or clipped items can be matched with the key topics and opinion orientation of the original curation and a visual guidance system can be generated which enables the user to obtain a more unbiased understanding of the information. By providing a more unbiased and sophisticated curation system, the embodiments described herein promote logical thinking and/or self-learning. This and other embodiments will be explained with reference to the accompanying drawings.

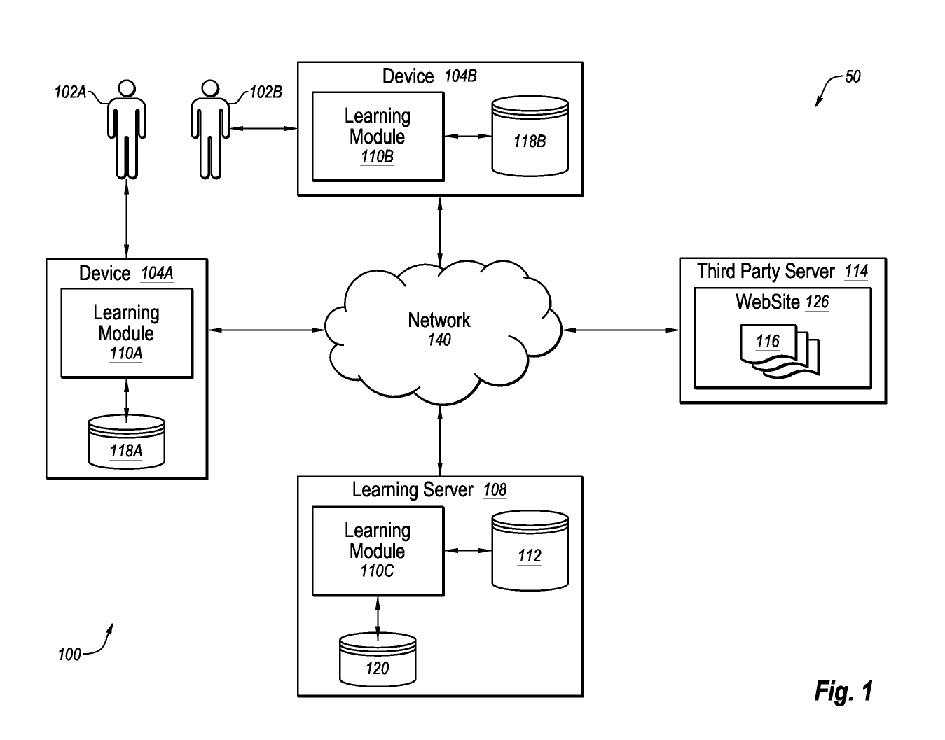

FIG. 1 illustrates a block diagram of an example operating environment 50 including an example informal learning system (learning system) 100. The learning system 100 may be configured in order to provide a more effective curation guidance and learning environment for a user in order to enhance logical thinking, facilitate updated curations of data, and promote self-learning using the operating environment 50.

In the depicted embodiment, the operating environment 50 may include two learners 102A and 102B (generally, learner 102 or learners 102). The learners 102 may include any individual or entity such as a student that is interfacing with the learning system 100. The learners 102 may be associated with devices 104A and 104B (generally, device 104 or devices 104). The devices 104, a third party server 114, and a learning server 108 may communicate via a network 140. For example, the devices 104, the third party server 114, and the learning server 108 may communicate learning materials via the network 140.

Additionally, in the learning system 100 of FIG. 1, the learning server 108 may include a learning module 110C. The learning module 110C may be configured to collect learning materials for informal learning. Specifically, in some embodiments, the learning module 110C may enable communication of the learning materials and/or information pertaining to the learning materials between the devices 104, the learning server 108, and the third party server 114 via the network 140.

The network 140 may be wired or wireless and may have numerous different configurations including, but not limited to, a star configuration, a token ring configuration, or other configurations. Furthermore, the network 140 may include a local area network (LAN), a wide area network (WAN) (e.g., the Internet), and/or other interconnected data paths across which multiple devices may communicate. In some embodiments, the network 140 may be a peer-to-peer network. The network 140 may also be coupled to or include portions of a telecommunications network that may enable communication of data in a variety of different communication protocols.

In some embodiments, the network 140 may include BLUETOOTH® communications networks and/or cellular communications networks for sending and receiving data including via short messaging service (SMS), multimedia messaging service (MMS), hypertext transfer protocol (HTTP), direct data connection, wireless application protocol (WAP), e-mail, etc.

The third party server 114 may include a hardware server that includes a processor, memory, and communication capabilities. In the illustrated embodiment, the third party server 114 may be coupled to the network 140 to send and receive information and data to and from the devices 104 and/or the learning server 108 via the network 140.

The third party server 114 may be configured to host a website 126 that is accessible via the network 140. Specifically, in some embodiments, the third party server 114 may allow access to the website 126 by the learners 102 using the devices 104, and/or the learning server 108 using the learning module 110. The learners 102, the devices 104, and the learning server 108 may accordingly access and/or interface with the website 126 via the network 140.

In particular, the website 126 may include one or more pages 116. Each of the pages 116 may be accessed by a first learner 102A using a first device 104A. The first device 104A, the second device 104B, the learning module 110C of the learning server 108, or any combination thereof may also access the website 126 including each of the pages 116 accessed by the first learner 102A as well as other pages 116 included in the website 126.

As used herein, accessing a given one of the pages 116 may include, but is not limited to, copying the page 116 to a system repository 112 or a personal repositories 118A and 118B (shown together in FIG. 1 as 112/118), adding the page 116 to a curation, bookmarking the page 116 in the learning system 100, performing analysis of the structure of the uniform resource locator (URL) of the page 116, performing a page structure analysis of the page 116, performing a content coherence analysis of the page 116, performing an analysis of the text of the page 116 in order to identify keywords, an opinion orientation of the page 116 with respect to a topic or keyword, or some combination thereof.

The devices 104 may include computing devices that include a processor, memory, and network communication capabilities. For example, each of the devices 104 may include a laptop computer, a desktop computer, a tablet computer, a mobile telephone, a personal digital assistant (“PDA”), a mobile e-mail device, a portable game player, a portable music player, a television with one or more processors embedded therein or coupled thereto or other electronic device capable of accessing the network 140.

The devices 104A and 104B may be configured to enable interaction with the learners 102. For example, the devices 104 may be configured to provide a user interface in a browser by using local learning modules 110A and 110B, respectively, that communicate with the learning module 110C of the learning server 108 to allow the learners 102 to create and modify curations, interact with existing curations or otherwise organize or browse content. In this and other embodiments, the devices 104 may provide the user interface. In some embodiments, the devices may include a program (e.g., a thin-client program) installed thereon that provides the user interface and/or one or more functions attributed to the devices 104.

The curations may include sets of learning materials, which may be related to a particular subject, that the learner 102 or other entity has combined and/or organized. For example, a curation may include items referring to multiple pages (e.g., the pages 116) from various sources related to a specific topic. In some embodiments, the devices 104 may enable the learners 102 to add an item to a curation via the learning module 110. The item may include learning material, a text document, an image, a video, an article, a series of articles, a portion of an article, graphics, or any other digital information in any form.

For example, the devices 104 may enable the learners 102 to access the pages 116 of the website 126 via the network 140. The learners 102 may then add the page 116 and/or add a bookmark to the page 116 to the curation. A signal may be communicated to the learning module 110C of the learning server 108 indicating the addition of the item. Additionally or alternatively, the learning module 110C may detect the addition of the item.

The learning module 110C may also be configured to track a date/time of when the item is added to the curation. For example, each time the first learner 102A adds the page 116 from the website 126, the learning module 110C may record or otherwise track the date/time of the addition. Additionally or alternatively, the devices 104 may record or otherwise track the date/time of the addition. The devices 104 may communicate data/time information to the learning module 110C of the learning server 108. Additionally or alternatively, the devices 104 may be configured to enable the learning module 110C of the learning server 108 to track the date/time of item additions.

Personal repositories 118A and 118B may store curations created by the learners 102A and 102B (referred to collectively as learner 102), the items included in the curations, and/or learning materials. In some embodiments, the personal repositories 118A and 118B may exist at least in part in the system repository 112. For example, the system repository 112 may include a portion designated for one or more of the learners 102, which may be a personal repository. Additionally or alternatively, the personal repositories 118A and 118B or some portion thereof may be located on the devices 104.

The learning server 108 may include a hardware server that includes a processor, a memory, and network communication capabilities. In the illustrated embodiment, the learning server 108 may be coupled to the network 140 to send and receive data to and from the devices 104 and/or the third party server 114 via the network 140. The learning server 108 may include the learning module 110. The learning module 110C may be configured to interact with the devices 104 and/or the third party server 114 to collect learning materials for informal learning in the learning system 100.

In some embodiments, one or both of the learners 102 may add an item to the curation. For example, the first learner 102A may use the first device 104A to add one of the pages 116 to the curation. Additionally or alternatively, the first learner 102A may use the first device 104A to bookmark one of the pages 116 in the curation. The learning module 110C may detect the addition of the item to the curation. In some embodiments, the learning module 110C of the learning server 108 may detect the addition of the item via the network 140. Additionally or alternatively, the devices 104 may detect the addition of the item and may communicate a signal indicating the addition of the item to the learning module 110.

The learning module 110C may then deposit the learning material in the personal repositories 118A and 118B and/or the system repository 112. For example, the first learner 102A may add the learning material as a new item to a curation.

Modifications, additions, or omissions may be made to the operating environment 50 and/or the learning system 100 without departing from the scope of the present disclosure. Specifically, embodiments of the operating environment 50 depicted in FIG. 1 include two learners 102, one third party server 114 hosting one website 126, and the learning system 100 that includes two devices 104 and one learning server 108. However, the present disclosure more generally applies to the operating environment 50 including one or more learners 102, one or more third party servers 114 hosting one or more websites 126, and the learning system 100 that may include one or more devices 104 and one or more learning servers 108, or any combination thereof.

Moreover, the separation of various components in the embodiments described herein is not meant to indicate that the separation occurs in all embodiments. In addition, it may be understood with the benefit of this disclosure that the described components may be integrated together in a single component or separated into multiple components.

The learning module 110C may include code and routines for analyzing content in order to identify keywords or to identify an opinion orientation of an item of content. For example, the learning module 110C may perform a scan of a webpage or other item of content and perform an analysis of the text, meta data, tags, or other data associated with the webpage in order to identify key topics discussed or associated with the webpage. Further, the learning module 110C may identify an opinion orientation of the webpage with respect to the key topics by identifying words which indicate an opinion orientation of an author or source of the webpage. In some instances, the learning module 110C may perform such analyses by identifying the frequency of certain words or phrases within the webpage or content.

The learning module 110C may include code and routines for analyzing content in order to identify keywords or to identify an opinion orientation of an item of curation and/or an item on a clipboard. For example, the learning module 110C may perform a scan of a webpage or other item of a curation or item on a clipboard and perform an analysis of the text, meta data, tags, or other data associated with the webpage in order to identify key topics discussed or associated with the webpage. Further, the learning module 110C may identify an opinion orientation of the webpage with respect to the key topics by identifying words which indicate an opinion orientation of an author or source of the webpage. In some instances, the learning module 110C may perform such analyses by identifying the frequency of certain words or phrases within the webpage or content.

As is described more fully below, the learning module 110C may also generate a notification template which includes a curation organized with respect to key topics and an opinion orientation of the various elements of the curation with respect to the key topics. For example, the learning module 110C may identify three or any other desired number of key topics within the items of the curation by identifying key topics which are most frequently mentioned or referenced in the content and the various items of the curation may be organized according to the identified opinion orientation, such as favorable, unfavorable, or neutral with respect to the key topics.

Furthermore, the learning module 110C may also generate a display which acts as a visual guide for the learner 102 that prompts the user to identify various viewpoints with respect to the identified keywords or topics in order to broaden the learner's 102 understanding of the topic.

In some embodiments, the learning module 110C act in part as a thin-client application that may be stored on a computing device (e.g., the devices 104) and in part as components that may be stored on the learning server 108, for instance. In some embodiments, the learning module 110C may be implemented using hardware including a field-programmable gate array (FPGA) or an application-specific integrated circuit (ASIC). In some other instances, the learning module 110C may be implemented using a combination of hardware and software. Additionally, the learning module 110C and/or the personal repositories 118A and 118B may be included on one or more of the devices 104.

In the operating environment 50, memory such as memory in the devices 104, the learning server 108, and the third party server 114 may include a non-transitory memory that stores data for providing the functionality described herein. The memory may be included in storage that may be a dynamic random access memory (DRAM) device, a static random access memory (SRAM) device, flash memory, or some other memory devices. In some embodiments, the storage also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

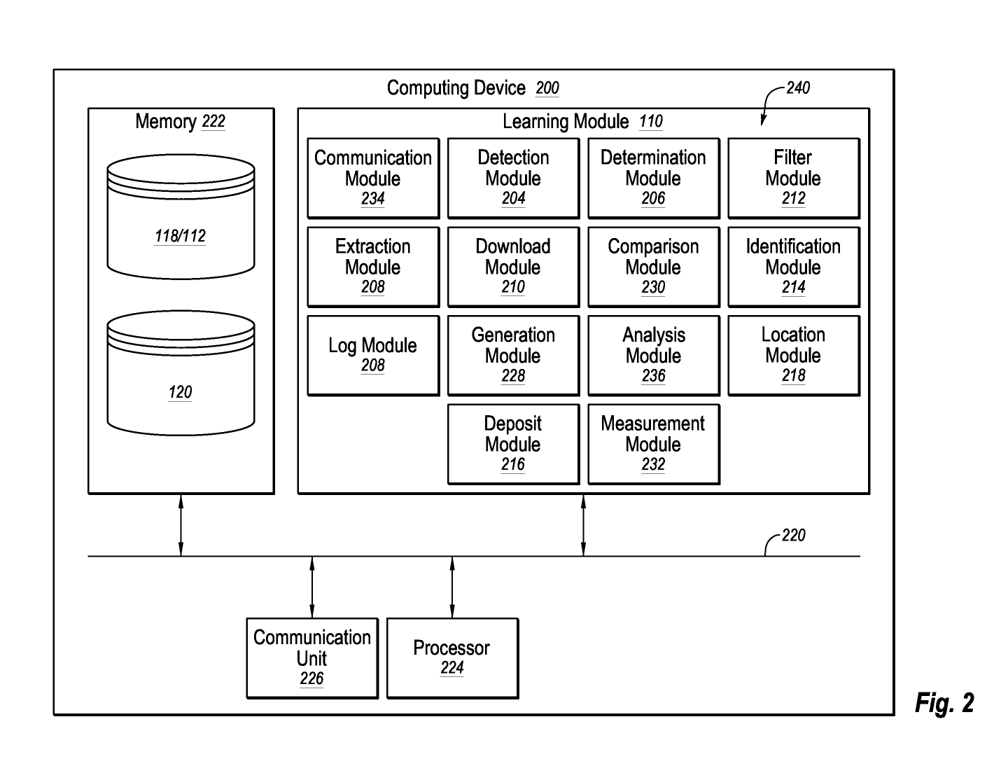

Referring now to FIG. 2, an example of the learning module 110C is shown in more detail. FIG. 2 is a block diagram of a computing device 200 that includes the learning module 110, a processor 224, a memory 222, and a communication unit 226. The components of the computing device 200 may be communicatively coupled by a bus 220. In some embodiments, the computing device 200 may include the learning server 108 or one of the devices 104 of the learning system 100 of FIG. 1.

With combined reference to FIGS. 1 and 2, the processor 224 may include an arithmetic logic unit (ALU), a microprocessor, a general-purpose controller, or some other processor array to perform computations and software program analysis. The processor 224 may be coupled to the bus 220 for communication with the other components (e.g., 110, 226, and 222). The processor 224 generally processes data signals and may include various computing architectures including a complex instruction set computer (CISC) architecture, a reduced instruction set computer (RISC) architecture, or an architecture implementing a combination of instruction sets. Although FIG. 2 includes a single processor 224, multiple processors may be included in the computing device 200. Other processors, operating systems, and physical configurations may be possible.

The memory 222 may be configured to store instructions and/or data that may be executed by the processor 224. The memory 222 may be coupled to the bus 220 for communication with the other components. The instructions and/or data may include code for performing the techniques or methods described herein. The memory 222 may be a DRAM device, an SRAM device, flash memory, or some other memory device. In some embodiments, the memory 222 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

In the depicted embodiment, the memory 222 includes the system repository 112, the personal repositories 118A and 118B, and the log 120. The system repository 112 and/or the personal repositories 118A and 118B may be configured to receive learning materials. The log 120 may be configured to receive, store, and enable access to a curation. Additionally, in some embodiments the system repository 112, the personal repositories 118A and 118B, or the log 120 may be configured to store and enable access to time/date information related to addition of items by the learners 102.

The communication unit 226 may be configured to transmit and receive data to and from at least one of the third party server 114, the devices 104, and the learning server 108 depending upon where the learning module 110C is stored. The communication unit 226 may be coupled to the bus 220. In some embodiments, the communication unit 226 may include a port for direct physical connection to the network 140 or to another communication channel. For example, the communication unit 226 may include a USB, SD, CAT-5, or similar port for wired communication with the components of the learning system 100. In some embodiments, the communication unit 226 may include a wireless transceiver for exchanging data via communication channels using one or more wireless communication methods, including IEEE 802.11, IEEE 802.16, BLUETOOTH®, or another suitable wireless communication method.

In some embodiments, the communication unit 226 may include a cellular communications transceiver for sending and receiving data over a cellular communications network including via SMS, MMS, HTTP, direct data connection, WAP, e-mail, or another suitable type of electronic communication. In some embodiments, the communication unit 226 may include a wired port and a wireless transceiver. The communication unit 226 may also provide other conventional connections to the network 140 for distribution of files and/or media objects using standard network protocols including transmission control protocol/internet protocol (TCP/IP), HTTP, HTTP secure (HTTPS), and simple mail transfer protocol (SMTP), etc.

In the embodiment of FIG. 2, the learning module 110C may include a communication module 234, a detection module 204, a determination module 206, an extraction module 208, a download module 210, a filter module 212, an identification module 214, a deposit module 216, a location module 218, a generation module 228, a comparison module 230, a measurement module 232, an analysis module 236, an assignment module 244, a calculation module 242, and a log module 238 (collectively, the modules 240). Each of the modules 240 may be implemented as software including one or more routines configured to perform one or more operations. The modules 240 may include a set of instructions executable by the processor 224 to provide the functionality described below. In some instances, the modules 240 may be stored in or at least temporarily loaded into the memory 222 of the computing device 200 and may be accessible and executable by the processor 224. One or more of the modules 240 may be adapted for cooperation and communication with the processor 224 and components of the computing device 200 via the bus 220.

The communication module 234 may be configured to handle communications between the learning module 110C and other components of the computing device 200 (e.g., 224, 222, and 226). The communication module 234 may be configured to send and receive data, via the communication unit 226, to the third party server 114, the devices 104, and/or the learning server 108. In some instances, the communication module 234 may cooperate with the other modules (e.g., 204, 206, 208, 210, 212, 214, 216, 218, 228, 230, 232, 236, 238, 242, and 244) to receive and/or forward, via the communication unit 226, data from one or more of the third party server 114, the devices 104, and the learning server 108.

The detection module 204 may be configured to detect occurrences in the computing device 200 or in the devices and/or the learning server 108. For example, the detection module 204 may detect an addition of an item to a curation. The addition of the item may include the learner 102 bookmarking the item in the curation and/or adding the item to the curation. The detection module 204 may receive an indication of the addition of the item via the communication unit 226 and the communication module 234 in some embodiments. The detection module 204 may communicate a signal to the extraction module 208 indicating the item has been added.

Additionally, in some embodiments, the communication module 234 may communicate the time/date of the addition to the log module 238. The log module 238 may be configured to log the time/date of the addition to the log 120 or another location in the memory 222 via the bus 220. The time/date of the addition may be stored in the log 120, for instance, with or without a rule generated based on the addition as discussed herein.

The extraction module 208 may be configured to extract information from items and pages. For example, the extraction module 208 may receive the signal from the detection module 204 indicating the item has been added. The extraction module 208 may extract one or more links, text, metadata, or other text from a page referenced by the item. The data corresponds to the pages 116, which may exist in the website 126 hosted by the third party server 114, for instance. The pages 116 may be accessible via the network 140.

The download module 210 may be configured to receive links and download the pages 116. For example, the download module 210 may download the pages 116 corresponding to the one or more of links in the page referenced by an item. The download module 210 may communicate the downloaded pages to the filter module 212.

The filter module 212 may be configured to filter downloaded pages based upon their content. For example, the filter module 212 may be configured to filter the downloaded pages to identify frequency of terms, phrases, links, or other data.

The identification module 214 may be configured to identify a source of a particular item of content and to identify whether there are related items of content in an index or other hierarchical structure. The comparison module 230 may be configured to compare various content in a curation in order to identify their similarities or differences.

The determination module 206 may be configured to determine the number key topics identified by the extraction module. The computing device may also include a measurement module 23, identification module 214 or the like for identifying related pages or other associated data with respect to a particular item of content.

The deposit module 216 may be configured to receive learning materials and deposit the learning materials in the personal repositories 118A and 118B and/or the system repository 112. For example, the deposit module 216 may receive the learning material and deposit the learning material in the personal repositories 118A and 118B.

After the rule is generated, the analysis module 236 may be configured to analyze the rule along with learning activities of multiple learners 102. Based on the analyzed learning activity, the determination module 206 may determine an extraction frequency. The communication module 234 may then fetch learning materials from the primary information block at the extraction frequency and the deposit module 216 may deposit the learning materials in the personal repositories 118A and 118B and/or the system repository 112.

In some embodiments, the analysis module 236 may coordinate with the communication module 234, the log module 238, and the determination module 206 to extract topics of the items within the curation, identify the opinion orientation of the items of the curation, generate the visualization of the key topics and opinion orientation of the items of the curation, notification template, guidance template, and visual guidance for presenting the information of the curation.

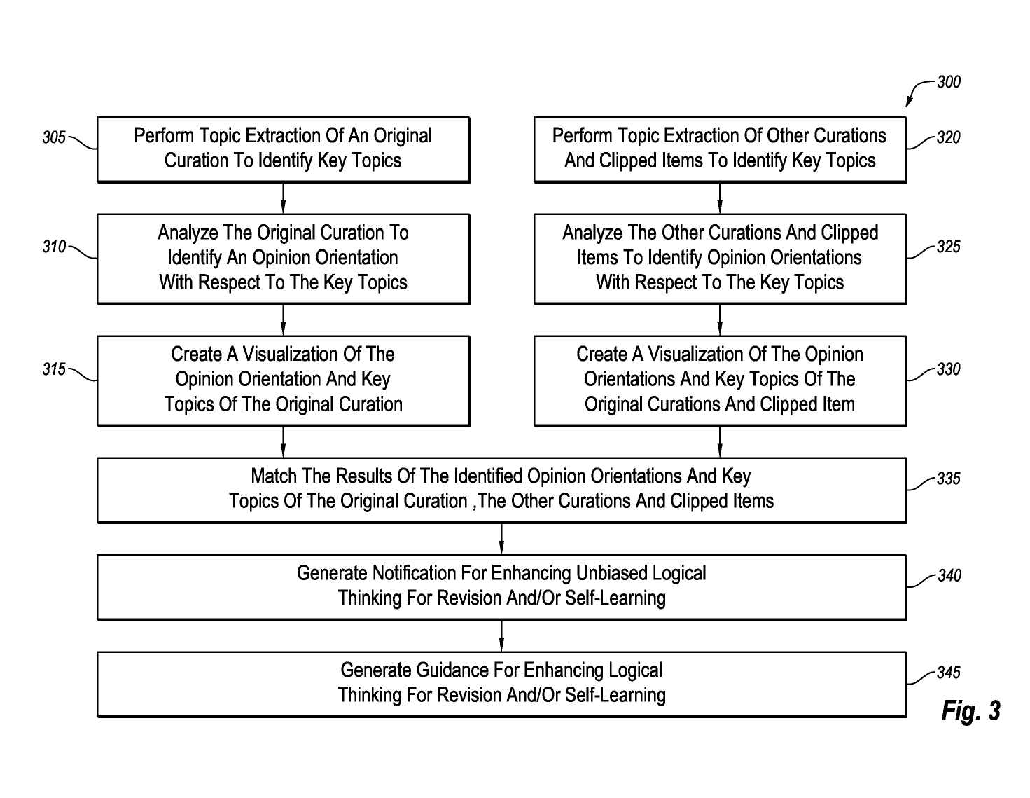

FIG. 3 is a flow diagram illustrating a method 300 which may be performed by embodiments of the invention, which provide a more effective guidance tool and educational system for enhancing a user's logical thinking skills. The method 300 also provides a more robust and sophisticated curation system and promotes self-learning by informing users of contradictory and similar content by analyzing the opinion orientation of the items. The method 300 begins at 305 where a topic extraction process is performed on an original curation. In one embodiment, the original curation may be a selection of items that are grouped together by an entity, where the entity is a user of the system 100.

A variety of different methods may be used to extract or identify the key topics of the content of the original curation. For example, the learning module 110C may perform a text extraction, identification, and analysis process, wherein words, phrases, or other text data are identified in the text of the content in order to identify key topics associated with the content. Further, the metadata, source, author, images, or other data associated with the content may be analyzed in order to identify key topics which are related to the content of the original curation.

One process may include scanning the title, notes, source, of the original curation. The learning module 110C then extracts key words including proper nouns, names, verbs, phrases, or other text in order to generate a list of key words. The learning module 110C may also analyze tags, metadata, photos, or other data associated with the content. All the collected information may be combined and analyzed by the learning module 110C in order to create a list of key words, phrases, or concepts which are identified or associated with the content of the newly-added curation, existing curation, and clipped items.

In some instances, a weight may be assigned to each key word or tag identified by the content of the curation according to the frequency of its use or association with a particular item of content. For example, a first item of content may discuss a variety of topics, but the topics may be weighted and sorted according to their frequency in order using designations such as 1 for a topic which is merely mentioned or less frequently discussed compared to other topics, with 2 being used to designate a topic which is relatively more prevalent and 3 being used to designate a topic which is most frequent or most likely to be the main topic of the item of content. Then a list of key topics and their associated weights may be generated for each item of the curation. Then the list of key topics may be generated in the order of their determined importance for each item of content in the curation.

Then at 310, the learning module 110C also analyzes the content in the original curation to identify the opinion orientation of the content with respect to the previously identified key topics at 305. This process may involve analyzing the text, metadata, author information, or other data or information associated with the items in the original curation with respect to the identified key topic in order to identify an opinion orientation of the items in the original curation. For example, the items of the curation may be analyzed to determine whether the content of the items present a “favorable,” “unfavorable” or “neutral” opinion or bias of information with respect the identified key topics. One example of a system and process which may be used to identify opinions from content or text documents is found in U.S. Pat. No. 7,865,354, entitled “Extracting and Grouping Opinions from Text Documents.”

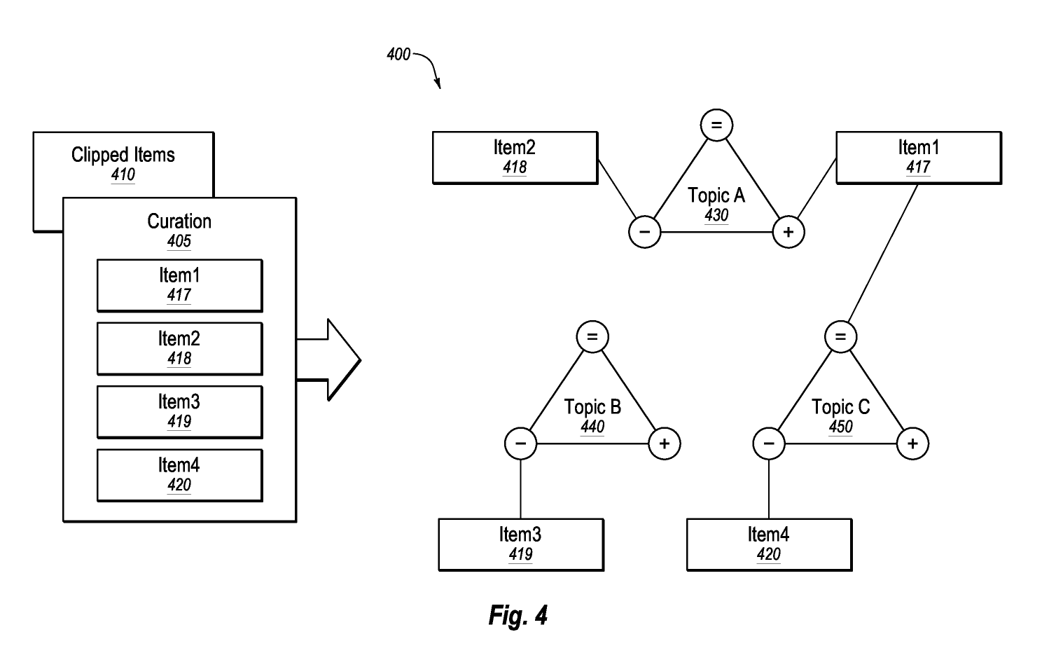

At 315 a visualization of the opinion orientation and key topics of the original curation is created. FIG. 4, described more fully below, is a block diagram which illustrates an example of how a group of items 417-420 in a curation 405 are analyzed to identify key topics 430, 440 and 450 and opinion orientations with respect to those key topics 430, 440, and 450. The items 417-420 are then organized in a visual representation 400 which illustrates the items 417-420 of the original curation 405 with respect to the identified key topics 430, 440, and 450 and which also illustrates the opinion orientation of the items 417-420 with respect to those identified key topics 430.

Returning to method 300 of FIG. 3, the topic extraction process is also performed on other or existing curations and clipped items at 320. More particularly, using methods similar to those described above, the items in the existing curations are analyzed to identify key topics. Then, at 325, the items of the existing curations and/or clipped items are analyzed in order to identify the opinion orientations of the items with respect to the identified key topics. At 330, a visualization of the items of the other curation and/or clipped items is displayed so as to illustrate the opinion orientation of the items with respect to the identified key topics.

The other curation may be a selection of items which have previously been grouped together as containing similar or relevant topics, such as the results of a search engine or other third party entity who may have created a curation or grouping of items. In yet another embodiment, the user may have identified and placed items on an electronic clipboard in preparation for a more thorough curation. In such an embodiment, the placement of the items onto the clipboard is considered along with another curation or in addition to another or other curation.

At step 335, the results of the identified opinion orientations and key topics of the original curation, other curations, and clipped items are matched. Then at 340 a notification is generated for enhancing unbiased logical thinking for revision and/or self-learning. At 345, guidance is provided for enhancing logical thinking for revision and/or self-learning. One example of a system and process which may be used to identify opinion orientations from content or text documents is found in U.S. Pat. No. 7,865,354, entitled “Extracting and Grouping Opinions from Text Documents.” Using the identified opinion orientation and key words, an opinion orientation template 400 may be generated at 430.

FIG. 4 illustrates an example of a visualization of content 417-420 in a curation 405 according to the identified opinion orientation of the content with respect to key topics 430, 440, and 450. In this example, the curation 405 is generated from clipped items 410 or in addition to a selection of clipped items 410 which a user may wish to add or further associated with the curation 405.

In the visualization 400 shown in FIG. 4, a first item of content 417 may discuss two different key topics, where the first key topic A 430 may be discussed in a favorable manner (as indicated by the ‘+’ designation shown in FIG. 4), whereas the second key topic C 450 may be described in a neutral manner (as indicated by the ‘=’ designation). Another item 418 in the curation 405 may discuss same first key topic A 430 in a negative viewpoint (as indicated by the ‘−’ designation), while the second key topic C 450 not discussed or omitted from the second item 418 in the curation 405. In such an instance, the first item 417 of curation 405 presents an opposing viewpoint from the second item 418 with respect to topic A 430, but the two items of curation 405, item 417 and item 418, do not present opposing viewpoints of topic C 450, since the second item 418 does not discuss the topic C 450. Rather, as is shown in FIG. 4, item 4 420 has been identified as presenting a negative viewpoint of topic C 450. As such, item 4 420 and item 1 417 may be compared in order to obtain a more sophisticated viewpoint of topic C 450.

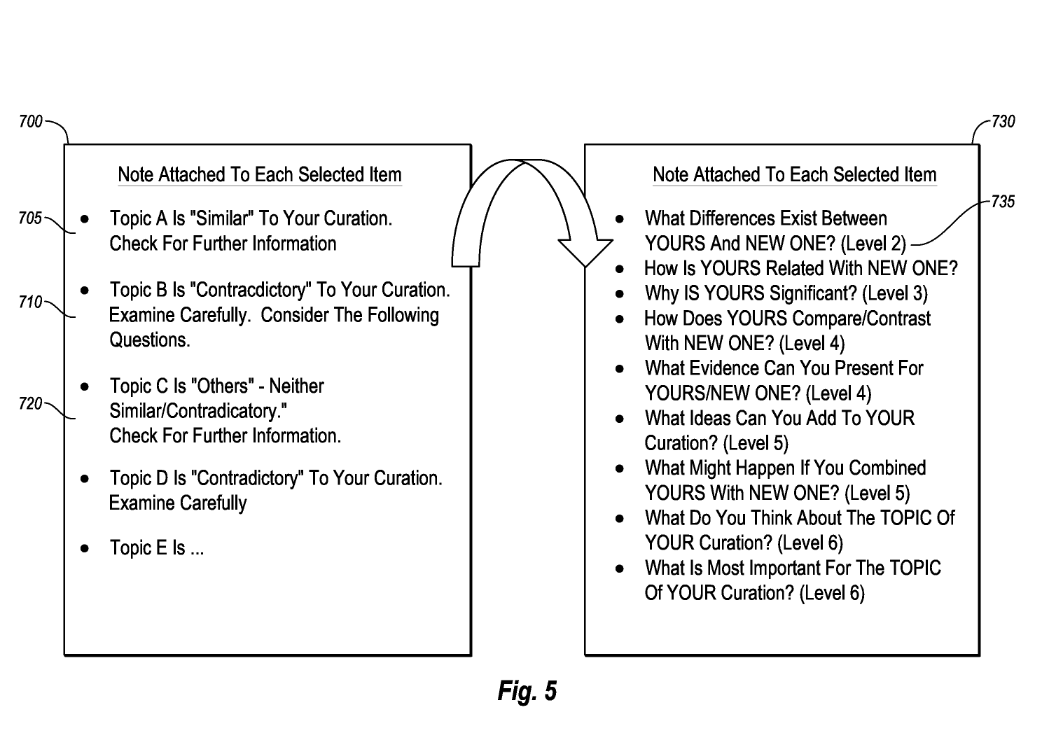

FIG. 5 illustrates a listing 700 of exemplary notes which can be generated using the enhanced learning platform described herein. For example, a note 705 may be added to a selected item of the original curation indicating that with respect to Topic A, the selected item contains a “similar” viewpoint to items in the newly-added curation, existing curation, and clipped items. Another note 710 may be generated when the selected item is “contradictory” to items in the newly-added curation, existing curation, and/or clipped items with respect to Topic B instructing the user to examine the contradictory references closely. Another note 720 may be generated when the selected item is “other” or not similar or contradictory in the newly-added curation, existing curation, and clipped items with respect to Topic C a note may be generated instructing the user to examine the references in order to check more information on the topic.

In addition, the system 100 may generate a list of questions 730 for contradictory items in order to deepen or broaden the user's 102 understanding. For example, the user 102 may be prompted to identify differences between the currently selected item of the original curation and items in the newly-added curation, existing curation, and clipped items.

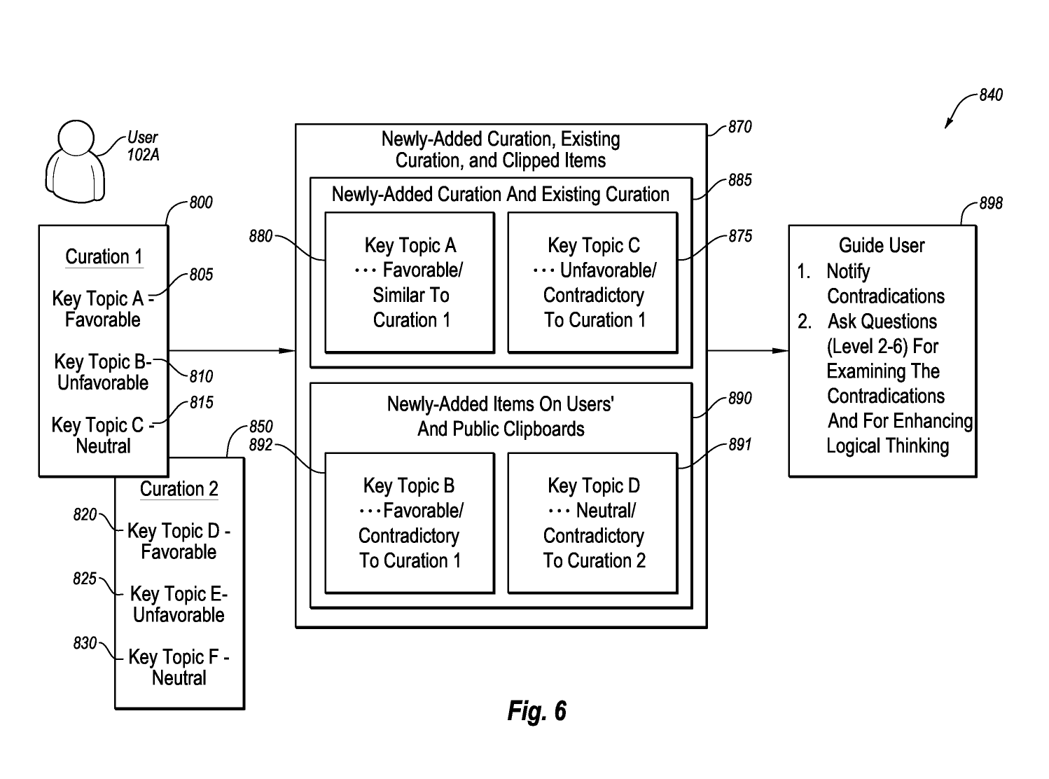

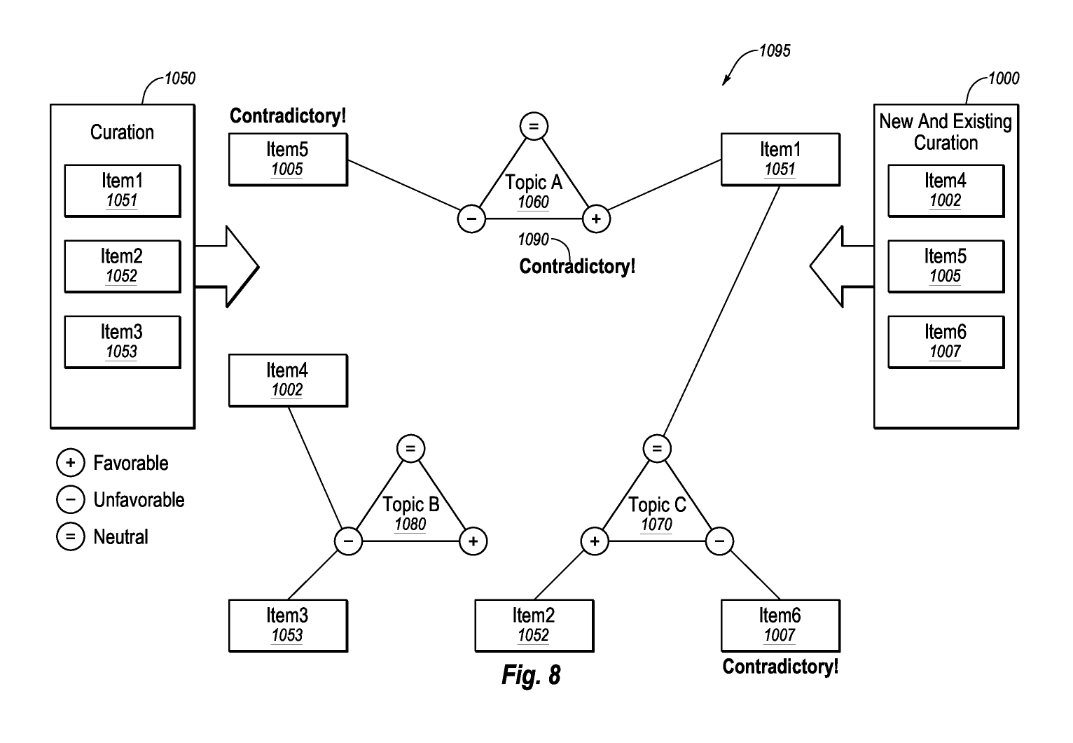

FIG. 6 is an example of the enhanced learning system 840 which may be presented to a user 102A. The example shown in FIG. 8, the system 840 includes two curations 800 and 850. The first curation 800 includes content which has been determined as being favorable with respect to key topic A 805, unfavorable with respect to key topic B 810, and neutral to key topic C 815. The second curation 850 includes content which has been determined as being favorable with respect to key topic D 820, unfavorable with respect to key topic E 825, and neutral to key topic F 830.

The user interface 870 of the curation guidance system 840 includes a newly-added curation, existing curation, and clipped items 870 which include a newly-added curation and existing curation 885 which includes content 880 which has a favorable and similar opinion orientation to a key topic A and content 875 which has an unfavorable and contradictory opinion orientation to a key topic C than the opinion orientation of the first curation 800. The newly-added curation, existing curation, and clipped items 870 also includes newly-added items 891 and 892 which have been added to the user's 102 clipboard or a public clipboard. The clipboards 890 include item 892 which has a favorable and contradictory opinion orientation to the key topic B which is also included in the first curation 800 and item 891 which has a neutral and contradictory opinion orientation to the key topic D of the second curation 850.

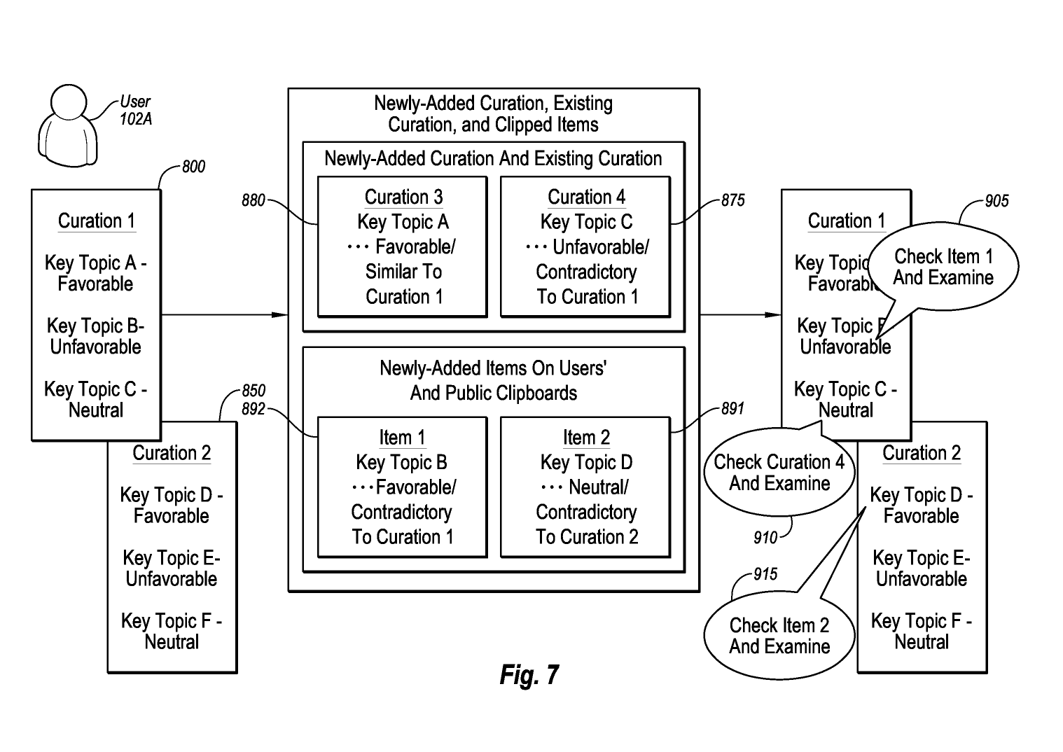

Once the newly-added curation, existing curation, and clipped items 870 have been identified, the system presents a notification 898 which notifies the user of contradictions or other relationships between the content that are determined to be useful in broadening the user's perspective on the topic. This may include asking the user questions or prompting the user to examine the contradictions in order to enhance logical thinking FIG. 7 illustrates the notifications 905, 910, and 915 identify contradictory items of content. For example, notification 905 notifies the user 102 of a contradictory viewpoint between the first curation 800 and the newly-added third curation 880 with respect to key topic A. Notification 910 notifies the user 102 of a potentially contradictory viewpoint between the first curation 800 and the newly-added fourth curation 875 with respect to key topic C. Notification 915 notifies the user 102 of a potentially contradictory viewpoint between the second curation 850 and the newly-added second item 891.

FIG. 8 is an example of an opinion orientation visualization 1095 which may result from a user's 102 interaction with the curation guidance system 100 of the embodiments described herein. The first curation 1050 includes item1 1051, item2 1052, and item3 1053 and the second, newly added curation 1000 includes item4 1002, item 5 1005, and item6 1007. As is shown in FIG. 8, item5 1005 and item1 1051 have contradictory viewpoints with respect to topic A 1060, while item1 1051, item6 1007, and item2 1052 have contradictory or differing viewpoints with respect to topic C 1070. Item4 1002 and item3 1053 have similar viewpoints with respect to topic B, and as such, no “contradictory” notification is generated.

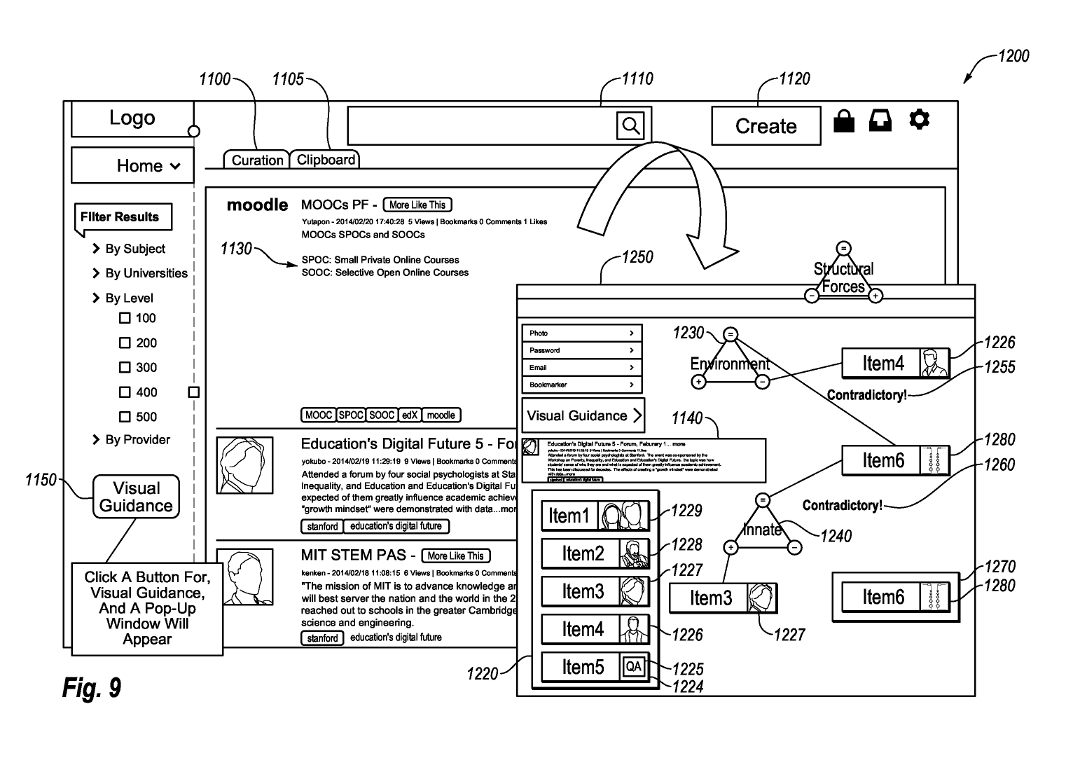

FIG. 9 is an example of how the curation guidance system 100 of the embodiments described herein may be used to create a curation of items or to add to an existing curation. As is shown in FIG. 9, the curation guidance system 100 may include a user interface 1200 which a user may use to search for newly-added curation, existing curations, and clipped items. In this example, the user may search for an existing curation using a search bar 1110C with which the user may enter keywords or other key topics. The system may then bring up a relevant list of item 1130 and 1140. The user may also select or search for individual items for storing in a clipboard 1105 which may subsequently be curated.

Based on the detected and manually inputted key words and opinion orientation content, the curation system 100 is able to generate a visual guidance or display of the data. For example, in the example shown in FIG. 9, by clicking on the visual guidance button 1250, a pop-up window 1250 appears, which presents a visual representation of the opinion orientation of items1 to item5 1224-1229 which are port of a selected curation 1240. As is shown in the visual guidance display of FIG. 9, item4 1226 discussed the environment in a positive or favorable viewpoint, whereas newly added item6 1480, which is part of a newly added curation 1270 or clipboard, discusses the same key topic of the “environment” in a neutral manner. Because item 6 1250 prevents a differing viewpoint than item4 1226, the system identifies the inconsistent viewpoint between the two items 1226 and 1280 and creates a “contradictory” notification 1255. Similarly, item6 1280 also discusses the key term “innate” 1240 in a neutral manner, which differs from the negative viewpoint of the key topic 1240 in item3 1227 of the existing curation 1220. Consequently, a “contradictory” notification 1260 is also generated to highlight the differing viewpoints.

As may be understood by one of skill in the art, the embodiments described herein assist in guiding a user through the process of finding and learning about different viewpoints of key topics in order to deepen or broaden the user's viewpoint on a particular key topic. Such a system provides a more effective learning and guidance tool than those currently known in the art and enhances logical thinking and helps users create more meaningful and robust curations.

The embodiments described herein may include the use of a special purpose or general purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include tangible computer-readable storage media including RAM, ROM, EEPROM, CD-ROM or other optical disk storage, magnetic disk storage or other magnetic storage devices, or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” may refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present invention have been described in detail, it should be understood that the various changes, substitutions, and alterations could be made hereto without departing from the spirit and scope of the invention.

What is claimed is:

1. A method of enhancing logical thinking in curation learning system including a learning module including a processor and a non-transitory computer storage medium, the method comprising:
receiving an original curation of a plurality of content;
analyzing the plurality of content of the original curation to identify a plurality of key topics which are associated with the content;
identifying an opinion orientation of the content of the original curation indicating an opinion orientation of the content of the original curation with respect to the key topics;
creating a visualization of the opinion orientation of the plurality of content of the original curation;
analyzing the plurality of content of an existing curation, newly-added curation, or clipped items in an electronic clipboard to identify a plurality of key topics which are associated with the content of the existing curation, newly-added curation, or clipped items in an electronic clipboard;
identifying an opinion orientation of the content of the existing curation, newly-added curation, or clipped items indicating an opinion orientation of the content of the existing curation, newly-added curation, or clipped items with respect to the key topics;
creating a visualization of the opinion orientation of the plurality of content of the existing curation, newly-added curation, or clipped items;
matching the identified opinion orientation and key topics of the plurality of content of the original curation and the plurality of content of the existing curation, newly-added curation, or clipped items;
generating a notification for enhancing the logical thinking of a user based on the matched identified opinion orientation and key topics of the plurality of content of the original curation and the plurality of content of the existing curation, newly-added curation, or clipped items; and
presenting the user with a guidance display for enhancing the logical thinking of a user based on the matched identified opinion orientation and key topics of the plurality of content of the original curation and the plurality of content of the existing curation, newly-added curation, or clipped items.

2. The method of claim 1, wherein identifying an opinion orientation of the original curation, existing curation, newly-added curation, or clipped items comprises determining whether the content references the key topics in a favorable, neutral, or negative viewpoint.

3. The method of claim 2, wherein detecting the similarity or dissimilarity between the at least two items of content includes detecting that both the at least two items of the plurality of content of the original curation, existing curation, newly-added curation, or clipped items have the same viewpoints or different viewpoints, respectively.

4. The method of claim 1, wherein identifying a plurality of key topics includes extracting and analyzing data associated with the plurality of content of the original curation existing curation, newly-added curation, or clipped items, the data being selected from a list consisting of text, metadata, address, tags, photos, web addresses, and sources.

5. The method of claim 2, wherein the guidance display includes presenting the user with a prompt requesting that the user identify the relationship between the at least two items of content of the original curation, existing curation, newly-added curation, or clipped items.

6. The method of claim 1, wherein identifying an opinion orientation of the plurality of content of the original curation and existing curation, newly-added curation, or clipped items comprises extracting and analyzing data associated with the plurality of content, the data being selected from a list consisting of text, metadata, address, tags, photos, web addresses, and sources.

7. The method of claim 6, wherein identifying an opinion orientation of the original curation, existing curation, newly added curation, and clipped items comprises determining whether the curated content references the key topics in a favorable, neutral, or negative viewpoint.

8. The method of claim 6, wherein identifying a plurality of key topics includes extracting and analyzing data associated with the plurality of content of the original curation, existing curation, newly added curation, and clipped items, the data being selected from a list consisting of text, metadata, address, tags, photos, web addresses, and sources.

9. The method of claim 6, wherein identifying an opinion orientation of the plurality of content of the original curation and existing curation, newly-added curation, or clipped items comprises extracting and analyzing data associated with the plurality of content of the original curation and the existing curation, newly-added curation, or clipped items, the data being selected from a list consisting of text, metadata, address, tags, photos, web addresses, and sources.

10. A non-transitory computer-readable medium having encoded thereon programming code executable by a processing device to perform the method of claim 6.

11. The method of claim 1, wherein matching the identified opinion orientation and key topics of the plurality of content of the original curation and existing curation, newly-added curation, or clipped items comprises:
detecting a similarity or dissimilarity between the plurality of content of the original curation and the plurality of content of the existing curation, newly-added curation, or clipped items based on the identified opinion orientation with respect to the identified key topics of both the original curation and the existing curation, newly-added curation, or clipped items; and
notifying the user of the similarity or dissimilarity between the original curation and the existing curation, newly-added curation, or clipped items based on the identified opinion orientation with respect to the identified key topics of both the original curation and the existing curation, newly-added curation, or clipped items.

12. The method of claim 11, wherein detecting the similarity or dissimilarity between the at least two items of content includes detecting that both the at least two items of the plurality of content of the original curation, existing curation, newly-added curation, or clipped items have the same viewpoints or different viewpoints, respectively.

13. The method of claim 11, wherein the guidance display includes presenting the user with a prompt requesting that the user identify the relationship between the at least two items of content of the original curation and the existing curation, newly-added curation, or clipped items.

14. A non-transitory computer-readable medium having encoded thereon programming code executable by a processing device to perform the method of claim 1.

15. A guided learning and curation system comprising:
a processor;
a non-transitory computer-readable storage medium communicatively coupled to the processor and having computer-executable instructions stored thereon that are executable by the processor to perform operations comprising:
receiving an original curation of a plurality of content;
analyzing the plurality of content of the original curation to identify a plurality of key topics which are associated with the content;
identifying an opinion orientation of the content of the original curation indicating an opinion orientation of the content of the original curation with respect to the key topics;
creating a visualization of the opinion orientation of the plurality of content of the original curation;
analyzing the plurality of content of an existing curation, newly-added curation, or clipped items in an electronic clipboard to identify a plurality of key topics which are associated with the content of the existing curation, newly-added curation, or clipped items in an electronic clipboard;
identifying an opinion orientation of the content of the existing curation, newly-added curation, or clipped items indicating an opinion orientation of the content of the existing curation, newly-added curation, or clipped items with respect to the key topics;
creating a visualization of the opinion orientation of the plurality of content of the existing curation, newly-added curation, or clipped items;
matching the identified opinion orientation and key topics of the plurality of content of the original curation and the plurality of content of the existing curation, newly-added curation, or clipped items;
generating a notification for enhancing the logical thinking of a user based on the matched identified opinion orientation and key topics of the plurality of content of the original curation and the plurality of content of the existing curation, newly-added curation, or clipped items; and
presenting the user with a guidance display for enhancing the logical thinking of a user based on the matched identified opinion orientation and key topics of the plurality of content of the original curation and the plurality of content of the existing curation, newly-added curation, or clipped items.

16. The system of claim 15, wherein identifying an opinion orientation of the original curation, existing curation, newly-added curation, or clipped items comprises determining whether the content references the key topics in a favorable, neutral, or negative viewpoint.

17. The system of claim 15, wherein matching the identified opinion orientation and key topics of the plurality of content of the original curation and existing curation, newly-added curation, or clipped items comprises:
detecting a similarity or dissimilarity between the plurality of content of the original curation and the plurality of content of the existing curation, newly-added curation, or clipped items based on the identified opinion orientation with respect to the identified key topics of both the original curation and the existing curation, newly-added curation, or clipped items; and
notifying the user of the similarity or dissimilarity between the original curation and the existing curation, newly-added curation, or clipped items based on the identified opinion orientation with respect to the identified key topics of both the original curation and the existing curation, newly-added curation, or clipped items.

18. The system of claim 17, wherein detecting the similarity or dissimilarity between the at least two items of content includes detecting that both the at least two items of the plurality of content of the original curation, existing curation, newly-added curation, or clipped items have the same viewpoints or different viewpoints, respectively.

19. The system of claim 18, wherein detecting the similarity or dissimilarity between the at least two items of content includes detecting that both the at least two items of the plurality of content of the original curation, existing curation, newly-added curation, or clipped items have the same viewpoints or different viewpoints, respectively.

20. The system of claim 17, wherein matching the identified opinion orientation and key topics of the plurality of content of the original curation and existing curation, newly-added curation, or clipped items comprises:
detecting a similarity or dissimilarity between the plurality of content of the original curation and the plurality of content of the existing curation, newly-added curation, or clipped items based on the identified opinion orientation with respect to the identified key topics of both the original curation and the existing curation, newly-added curation, or clipped items; and
notifying the user of the similarity or dissimilarity between the original curation and the existing curation, newly-added curation, or clipped items based on the identified opinion orientation with respect to the identified key topics of both the original curation and the existing curation, newly-added curation, or clipped items.

21. The system of claim 15, wherein identifying a plurality of key topics includes extracting and analyzing data associated with the plurality of content of the original curation existing curation, newly-added curation, or clipped items, the data being selected from a list consisting of text, metadata, address, tags, photos, web addresses, and sources.

22. The system of claim 15, wherein the guidance display includes presenting the user with a prompt requesting that the user identify the relationship between the at least two items of content of the original curation, existing curation, newly-added curation, or clipped items.

23. The system of claim 15, wherein identifying an opinion orientation of the plurality of content of the original curation and existing curation, newly-added curation, or clipped items comprises extracting and analyzing data associated with the plurality of content, the data being selected from a list consisting of text, metadata, address, tags, photos, web addresses, and sources.

24. The system of claim 15, wherein identifying a plurality of key topics includes extracting and analyzing data associated with the plurality of content of the original curation, existing curation, newly-added curation, or clipped items, the data being selected from a list consisting of text, metadata, address, tags, photos, web addresses, and sources.

25. The system of claim 15, further consisting assigning a weight to key topics which are most frequently referenced in the plurality of content of the original content and the plurality of content of the existing curation, newly-added curation, or clipped items.
